(19) United States
(12) Patent Application Publication
(10) Pub. No.: US 2023/0391122 A1
(43) Pub. Date: Dec. 7, 2023

(54) PRINTING APPARATUS AND CONTROL METHOD

(71) Applicant: CANON KABUSHIKI KAISHA, Tokyo (JP)

(72) Inventors: YUNA HATTORI, Kanagawa (JP); AKIYOSHI SAHARA, Chiba (JP); KENGO NIEDA, Kanagawa (JP); MASAHITO YOSHIDA, Saitama (JP)

(21) Appl. No.: 18/308,508

(22) Filed: Apr. 27, 2023

(30) Foreign Application Priority Data
Jun. 3, 2022 (JP) 2022-090875

(51) Int. Cl. B41J 29/393; B41J 29/13; B41J 2/165

(52) U.S. Cl. CPC B41J 29/393; B41J 29/13; B41J 2/165

(57) ABSTRACT

There is provided a technique in which even in a case where an operation is stopped during maintenance processing including a plurality of phases, the maintenance processing can be executed properly. A maintenance unit executes maintenance processing including a plurality of maintenance operations for well maintaining and recovering liquid ejection from a printing unit configured to print a print medium, and in a case where the maintenance processing is executed, a control unit capable of controlling the maintenance processing executes first control to interrupt the maintenance processing in a case where the maintenance operations are changed by moving the printing unit.

### BACKGROUND OF THE INVENTION

### Field of the Invention

The present invention relates to a printing apparatus including a maintenance mechanism capable of well maintaining and recovering liquid ejection, and a method of controlling the printing apparatus.

### Description of the Related Art

Japanese Patent Laid-Open No. 2018-020460 discloses a printing apparatus capable of changing a maintenance operation for well maintaining and recovering the performance of ink ejection from a print head by moving a carriage. In such a printing apparatus, maintenance processing including a plurality of phases each including a plurality of maintenance operations is executed.

Japanese Patent Laid-Open No. 2004-276391 discloses a printing apparatus capable of interrupting a maintenance operation which is being executed in a case where an ink cartridge drops off during the maintenance operation and resuming the maintenance operation after the ink cartridge is properly mounted.

In the printing apparatus disclosed in Japanese Patent Laid-Open No. 2018-020460, in a case where an operation which is being executed is stopped during maintenance processing including a plurality of phases, the maintenance processing cannot be executed properly unless the maintenance operations and movement of the carriage are controlled. However, such a technique is not disclosed in Japanese Patent Laid-Open No. 2018-020460 nor in Japanese Patent Laid-Open No. 2004-276391.

### SUMMARY OF THE INVENTION

The present invention is made in view of the above problem and provides a technique in which even in a case where an operation is stopped during maintenance processing including a plurality of phases, the maintenance processing can be executed properly.

In the first aspect of the present invention, there is provided a printing apparatus including:
a maintenance unit capable of executing maintenance processing including a plurality of maintenance operations for well maintaining and recovering liquid ejection from a printing unit configured to print a print medium; and
a control unit capable of controlling the maintenance processing and configured to, in a case where the maintenance processing is executed, execute first control to interrupt the maintenance processing in a case where the maintenance operations are changed by moving the printing unit.

In the second aspect of the present invention, there is provided a printing apparatus including:
a holding unit configured to hold a print medium;
a conveying unit configured to convey the print medium held by the holding unit;
a printing unit configured to print the print medium;
a cap configured to cap a nozzle surface on which a nozzle from which liquid is ejected is formed in the printing unit;
a cover member displaceable between a closed position where a storage portion storing the print medium in the holding unit is blocked from an outside and an open position where the storage portion is exposed to the outside; and
a control unit configured to execute a process of prompting setting of the print medium after capping the nozzle surface with the cap in a case where an instruction is given to start setting the print medium in the holding unit, regulate an operation of the cap in a case where the cover member is in the open position in a state where the instruction is not given to start setting the print medium in the holding unit, and release the regulation based on displacement of the cover member from the open position to the closed position to execute a process of capping the nozzle surface with the cap.

In the third aspect of the present invention, there is provided a method of controlling a printing apparatus including a maintenance unit capable of executing maintenance processing including a plurality of maintenance operations for well maintaining and recovering liquid ejection from a printing unit configured to print a print medium,
wherein in a case where the maintenance processing is executed, the maintenance operations are interrupted in a case where the maintenance operations are changed by moving the printing unit.

In the fourth aspect of the present invention, there is provided a method of controlling a printing apparatus including:
a holding unit configured to hold a print medium;
a conveying unit configured to convey the print medium held by the holding unit;
a printing unit configured to print the print medium;
a cap configured to cap a nozzle surface on which a nozzle from which liquid is ejected is formed in the printing unit; and
a cover member displaceable between a closed position where a storage portion storing the print medium in the holding unit is blocked from an outside and an open position where the storage portion is exposed to the outside,
wherein a process of prompting setting of the print medium is executed after capping the nozzle surface with the cap in a case where an instruction is given to start setting the print medium in the holding unit, and
wherein an operation of the cap is regulated in a case where the cover member is in the open position in a state where the instruction is not given to start setting the print medium in the holding unit, and the regulation is released based on displacement of the cover member from the open position to the closed position to cap the nozzle surface with the cap.

According to the present invention, even in a case where an operation is stopped during maintenance processing including a plurality of phases, the maintenance processing can be executed properly.

Further features of the present invention will become apparent from the following description of exemplary embodiments with reference to the attached drawings.

### BRIEF DESCRIPTION OF THE DRAWINGS

FIG. 1 is a perspective configuration diagram of a printing apparatus;

FIG. 2 is a schematic configuration diagram of a main portion centered on a printing portion of the printing apparatus;

FIGS. 3A and 3B are schematic configuration diagrams of the inside of the printing apparatus;

FIG. 4 is a schematic configuration diagram of a main portion centered on a mechanism changing a maintenance member in a maintenance portion;

FIGS. 5A to 5D are diagrams for explaining an operation of the mechanism changing the maintenance member;

FIGS. 6A to 6D are diagrams for explaining the position of a projecting member according to the opening and closing of an access cover;

FIGS. 7A and 7B are perspective views showing the projecting member at the time of the opening and closing of the access cover;

FIG. 8 is a diagram showing a carriage in an engagement position;

FIG. 9 is a block diagram showing a configuration of a control system of the printing apparatus;

FIG. 10 is a flowchart showing a detailed process routine of maintenance processing;

FIGS. 11A and 11B are diagrams showing a state where a roll cover is open;

FIG. 12 is a flowchart showing a detailed process routine of first capping processing;

FIG. 13 is a flowchart showing a detailed process routine of roll set processing; and

FIG. 14 is a flowchart showing a detailed process routine of second capping processing.

### DESCRIPTION OF THE EMBODIMENTS

An example of embodiments of a printing apparatus and a control method will be described in detail below with reference to the accompanying drawings. It should be noted that the following embodiments do not limit the present invention, and not all combinations of features described in the present embodiments are essential to the solution of the problem to be solved by the present invention. Further, the positions, shapes, and the like of constituent elements described in the embodiments are merely examples and are not intended to limit the scope of the present invention only to them.

### First Embodiment

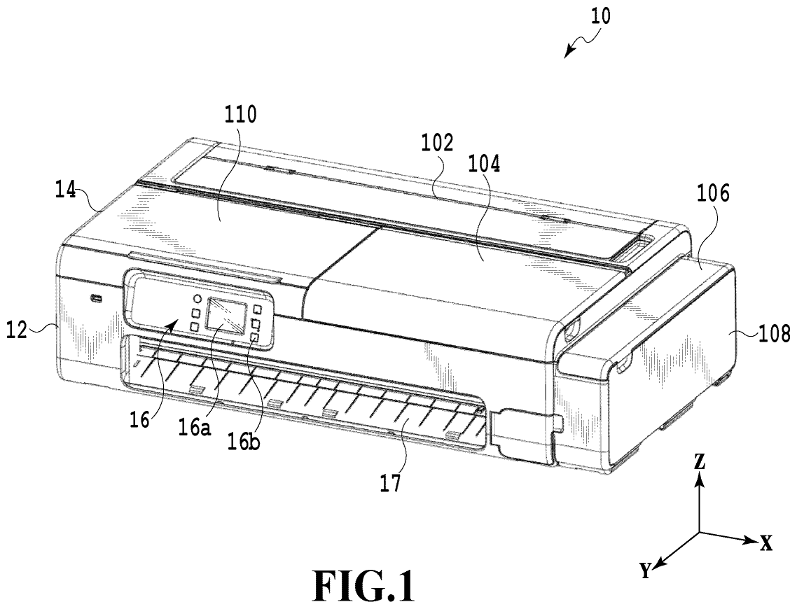

First, a printing apparatus according to a first embodiment will be described with reference to FIGS. 1 to 10.

### Configuration of the Printing Apparatus

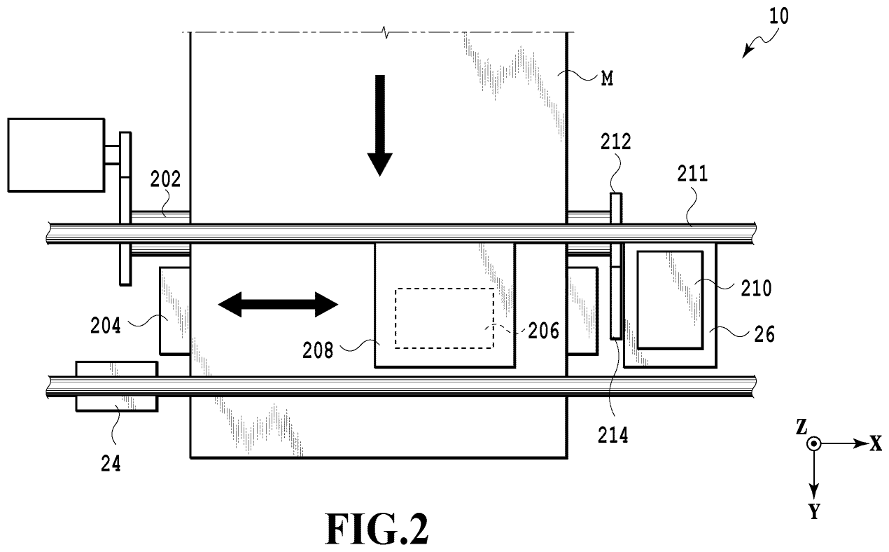

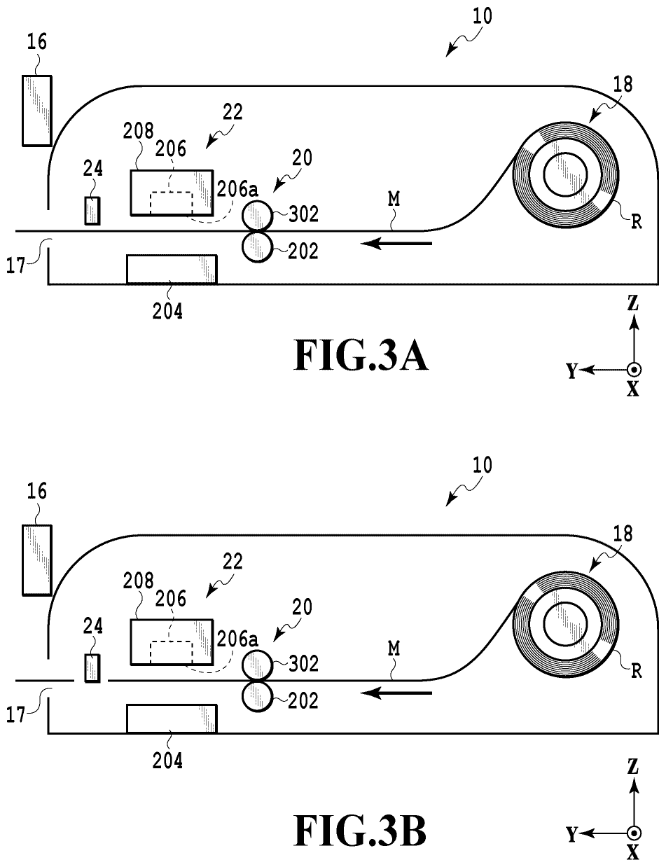

FIG. 1 is a perspective configuration diagram of the printing apparatus. FIG. 2 is a schematic configuration diagram of a main portion centered on a printing portion of the printing apparatus. FIGS. 3A and 3B are schematic configuration diagrams of the inside of the printing apparatus. The printing apparatus according to the present embodiment is an inkjet printing apparatus in which a print head ejects ink onto a print medium conveyed in a Y direction while moving in an X direction intersecting (in the present embodiment, orthogonal to) the Y direction to print an image. In the following description, the X direction and the Y direction indicate horizontal directions orthogonal to each other, and a Z direction indicates a vertical direction (up-and-down direction). “Printing” includes not only the case of forming significant information such as characters and figures, but also a broad case of forming images, patterns, and the like on a print medium irrespective of significance or insignificance or of performing processing of a medium, irrespective of whether they are elicited so that humans can perceive them visually.

The printing apparatus 10 has a flat rectangular parallelepiped shape as a whole and includes a main body portion 12 and a cover portion 14 having a plurality of covers that cause an internal constituent of the main body portion 12 to be exposed to or blocked from the outside by being opened or closed. The printing apparatus 10 also includes an input/output portion 16 capable of providing various inputs and outputting various types of information through a user's operation. The input/output portion 16 includes, for example, a display portion 16a capable of displaying various types of information, a hard key 16b for performing various operations such as various settings, and the like. The input/output portion 16 may be, for example, a touch panel. The input/output portion 16 may also be provided with a speaker or the like to output audio information (such as a beep and a voice).

### Main Body Portion

First, the configuration of the main body portion 12 will be described in detail below. The main body portion 12 includes a holding portion 18 that holds a roll R formed by winding a sheet-like print medium M, a conveying portion 20 that conveys the print medium M unwound from the roll R in the Y direction, and a printing portion 22 that performs printing on the print medium M conveyed by the conveying portion 20. The main body portion 12 is also provided with a cutting portion 24 capable of cutting a print medium after printing in a predetermined position and a maintenance portion 26 that performs a maintenance operation for well maintaining and recovering the performance of ink ejection from the printing portion 22.

The holding portion 18 is provided upstream of the printing portion 22 in the Y direction, that is, in a conveyance direction of a print medium, and the cutting portion 24 is provided downstream of the printing portion 22 in the Y direction. In the present embodiment, the roll R is held by the holding portion 18, and printing is performed on the print medium M unwound from the roll R. However, a cut sheet may be held as a print medium, or both roll and cut sheet may be held. Further, the holding portion 18 is configured to be able to rotate the roll in a direction in which the unwound print medium M is pulled back from the conveying portion 20 in a case where the printing portion 22 does not execute printing on the print medium M.

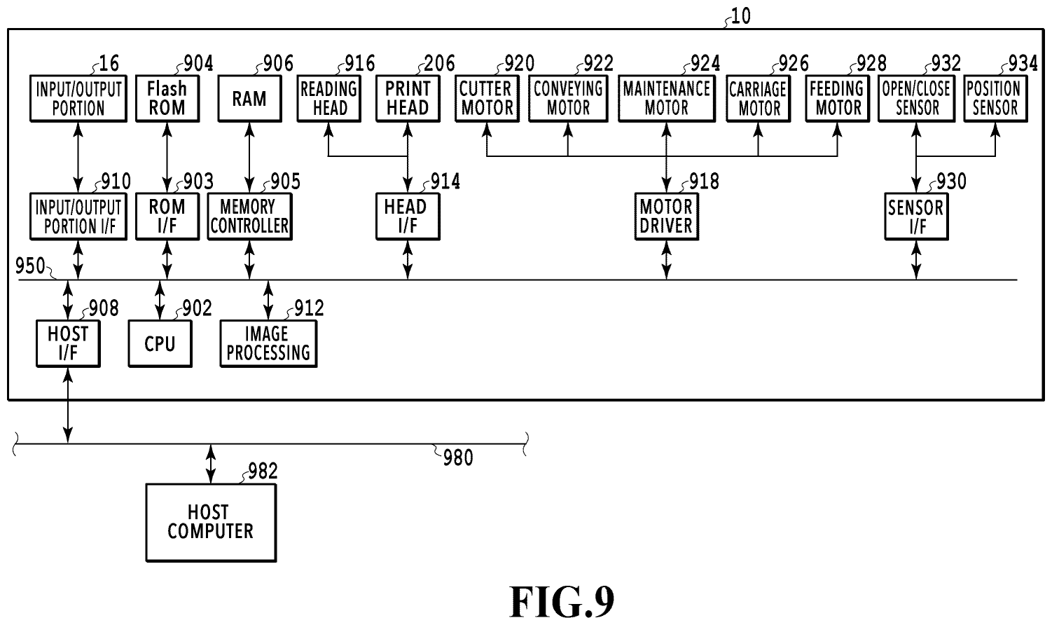

The conveying portion 20 includes a conveying roller 202 rotated by driving a conveying motor 922 (see FIG. 9) and a driven roller 302 that is in pressure contact with the conveying roller 202 and rotates along with the rotation of the conveying roller 202. The print medium M unwound from the roll R in the holding portion 18 and fed is nipped by the conveying roller 202 and the driven roller 302 and is conveyed in the Y direction as the conveying roller 202 rotates. That is, in the printing apparatus 10, a print medium is nipped by the conveying roller 202 during printing. In a non-printing state, the holding portion 18 pulls back the print medium M, so that the print medium is not nipped by the conveying roller 202, that is, is separated from the conveying roller 202.

The printing portion 22 includes a platen 204 capable of supporting the print medium M conveyed by the conveying portion 20 and a print head 206 that ejects ink onto the print medium M supported by the platen 204. The printing portion 22 also includes a carriage 208 mounted with the print head 206 and configured to be movable in the X direction. The print head 206 is mounted on the carriage 208 so that a nozzle surface 206a on which a plurality of nozzles for ejecting ink are formed faces the platen 204. The carriage 208 is slidably provided on a guide rail 211 extending in the X direction and is configured to be movable in a +X direction and a −X direction by driving the carriage motor 926 (see FIG. 9). Thus, in the printing apparatus 10, the print head 206 is configured to be movable in the +X direction and the −X direction via the carriage 208.

Then, in the printing apparatus 10, after moving the print medium M conveyed by the conveying portion 20 to a print start position, a printing operation is performed in which ink is ejected onto the print medium M while moving the print head 206 in the X direction to perform printing. Next, the conveying portion 20 performs a conveying operation to move the print medium M by a predetermined amount in the Y direction to position an area which has not been printed yet in a position facing the nozzle surface 206a of the print head 206 and performs the printing operation again. By alternately and repeatedly executing the printing operation and the conveying operation in this way, printing is performed on the print medium M based on print data in the printing apparatus 10. After that, the print medium M is cut by the cutting portion 24 for each image of one page and is discharged from a discharge port 17.

The maintenance portion 26 is located downstream of the platen 204 in the +X direction and is provided in a position where maintenance of the print head 206 can be performed in a case where the print head 206 is in a standby position where the print head 206 is located at a time at which printing is not performed. Incidentally, the maintenance portion 26 may also be located upstream of the platen 204 in the +X direction. The maintenance portion 26 includes a maintenance member for well maintaining and recovering ink ejection performance in the print head 206. For example, the maintenance portion 26 includes a cap 210 for capping the nozzle surface 206a of the print head 206. Incidentally, the maintenance member provided in the maintenance portion 26 is not limited to the cap 210 but includes, for example, various publicly-known maintenance members such as a wiping member for wiping the nozzle surface 206a.

The cap 210 provided in the maintenance portion 26 is configured to be movable in the Z direction, that is, to be able to be lifted and lowered. By being lifted, the cap 210 is used to cap the nozzle surface 206a of the print head 206 located in the standby position to protect the nozzle surface 206a and suppress evaporation of an ink liquid component from a nozzle. In the printing apparatus 10, for example, after the elapse of a certain period of time in a print standby state where a next print instruction is waited for, control is performed under the control of a CPU 902 (to be described later) so that the nozzle surface 206a of the print head 206 is capped with the cap 210.

The cap 210 is also configured to be able to receive ink therein. This brings about a state where the nozzle surface 206a of the print head 206 located in the standby position is separated from the cap 210, and ejecting ink from the nozzle in this state makes it possible to perform preliminary ejection, which is ink ejection that does not contribute to printing. In a case where the nozzle surface 206a of the print head 206 is not capped, periodically executing the preliminary ejection makes it possible to discharge ink in which thickening and solidification are accelerated from each nozzle on the nozzle surface 206a.

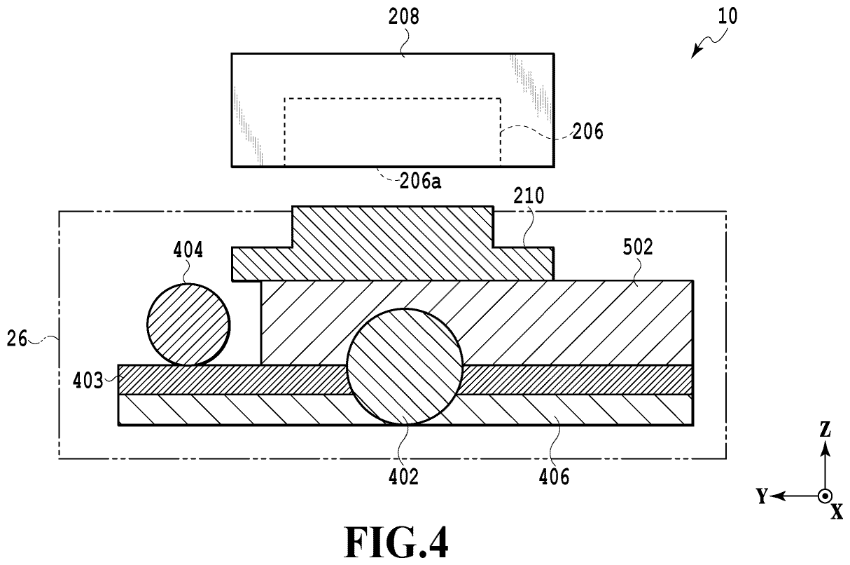

Further, the cap 210 is connected to a pump 402 (see FIG. 4) via a tube or the like. Then, driving the pump 402 in a state where the cap 210 abuts the nozzle surface 206a of the print head 206, that is, in a capped state makes it possible to forcibly suck ink from each nozzle on the nozzle surface 206a. As a result, bubbles and the like generated in the ink inside the print head 206 can be removed. Further, driving the pump 402 in a state where the cap 210 is separated from the nozzle surface 206a of the print head 206 makes it possible to perform an idle suction operation in which ink accumulated inside the cap 210 is collected in a waste ink collection body (not shown) or the like by preliminary ejection or the like. This idle suction operation can prevent ink from overflowing from the cap 210 and the ink in the cap 210 from adhering to the nozzle surface 206a and the vicinity of the nozzle during capping.

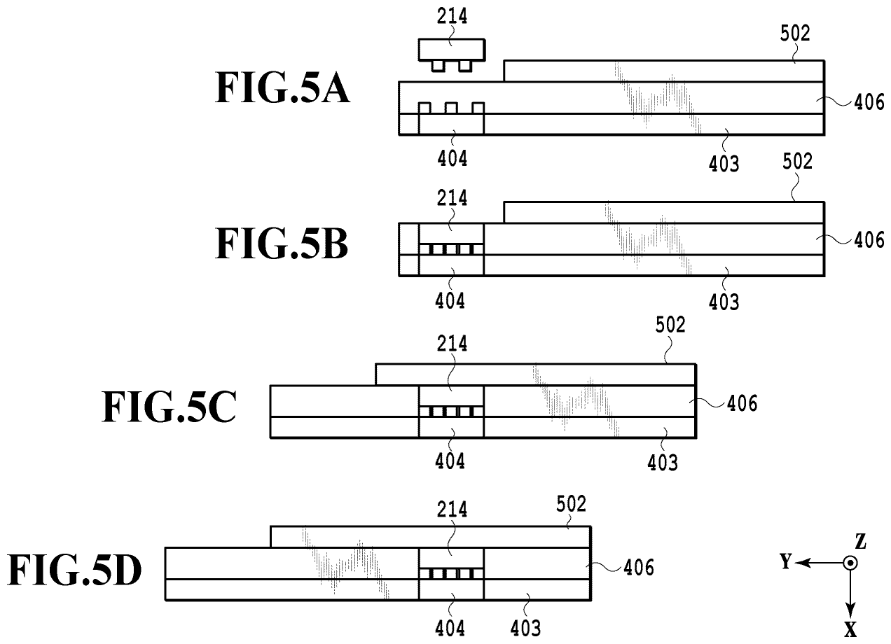

The maintenance portion 26 is configured to be able to change a maintenance operation to be executed by rotating the conveying roller 202 by driving the conveying motor 922. Here, a configuration in which the maintenance operation is changed will be described. FIG. 4 and FIGS. 5A to 5D are diagrams for explaining a mechanism capable of changing the maintenance operation executed in the maintenance portion.

In the conveying roller 202, a gear 212 provided near a downstream end of the conveying roller 202 in the +X direction engages a gear 214 capable of transmitting driving force to the maintenance portion 26 (see FIG. 2). As a result, the driving force of the conveying roller 202 is transmitted to the gear 214 via the gear 212. The gear 212 and the gear 214 do not necessarily have to be directly engaged with each other, and there may be one or more gears between the gear 212 and the gear 214, provided that the driving force of the conveying roller 202 can be transmitted to the gear 214 via the gear 212.

The gear 214 is configured to be movable between a position where the gear 214 engages the gear 404 and a position where the gear 214 is away from the gear 404. For example, in a case where the carriage 208 moves to a predetermined position (engagement position) on a downstream side in the +X direction of a printing area where printing can be executed, the carriage 208 presses a movement mechanism of the gear 214, and the movement mechanism moves the gear 214 to a position where the gear 214 engages the gear 404. Further, in a case where the carriage 208 moves upstream of the predetermined position in the +X direction, the pressure on the movement mechanism by the carriage 208 is released, and the gear 214 moves to a position where the gear 214 is away from the gear 404.

The gear 404 is connected to a plate-like plate member 406 via a guide 403. The rotation of the gear 404 due to the rotation of the gear 214 allows the plate member 406 to move in the Y direction. In the maintenance portion 26, the movement of the plate member 406 makes it possible to change a maintenance operation such as the capping operation and the idle suction operation. Therefore, the driving force of the conveying roller 202 is transmitted to the plate member 406 via the gears 212, 214, and 404 and causes the plate member 406 to move in the Y direction.

Specifically, in a case where the carriage 208 moves to the predetermined position, a state where the gear 214 is separated from the gear 404 (see FIG. 5A) shifts to a state where the gear 214 engages the gear 404 (see FIG. 5B). In a case where the conveying roller 202 is rotated by driving the conveying motor 922 with the gear 214 and the gear 404 engaged with each other, the driving force is transmitted via the gears 212, 214, and 404, and the plate member 406 moves in the +Y direction. Thus, in order not to transmit the driving force of the conveying motor 922 to the plate member 406, the gear 212 and the gear 214 are kept separated from each other by preventing the carriage 208 from moving to the predetermined position.

The plate member 406 includes a guide 502, and in a case where the plate member 406 is moved in the +Y direction by driving the conveying motor 922, the guide 502 generates force to push the gear 214 toward the gear 404 (downstream in the +X direction). As a result, a state of transmitting the driving force of the conveying motor 922 is maintained. Incidentally, in the case of printing or the like, the plate member 406 is moved in the −Y direction by driving the conveying motor 922, so that the force of the guide 502 to push the gear 214 toward the gear 404 is prevented from being generated (see FIG. 5B). Further, by moving the carriage 208 in the −X direction, separating the carriage 208 from the predetermined position, and separating the gear 214 from the gear 404 (see FIG. 5A), driving force is not transmitted to the maintenance portion 26.

In the present embodiment, moving the plate member 406 to a position shown in FIG. 5C and driving a maintenance motor 924 (see FIG. 9) that serves as a drive source for the maintenance operation by the maintenance portion 26 cause the idle suction operation. Further, moving the plate member 406 to a position shown in FIG. 5D and driving the maintenance motor 924 cause the cap 210 to be lifted to perform the capping operation of capping the nozzle surface 206a of the print head 206. To facilitate understanding, descriptions using FIGS. 4 and 5A to 5D are given using, as an example, the maintenance operation using the cap 210. However, in the printing apparatus 10, the plate member 406 can be moved to execute a maintenance operation by another maintenance member, such as wiping by a wiping member. Incidentally, the driving force of the conveying motor 922 may be used to drive the maintenance member.

### Cover Portion

Next, the configuration of the cover portion 14 will be described in detail below. The cover portion 14 includes a plurality of cover members, is provided to cover the upper surface of the main body portion 12, and constitutes the top portion of the printing apparatus 10 (see FIG. 1). The cover portion 14 includes a roll cover 102 that is opened and closed in setting a roll in the holding portion 18 and an access cover 104 that is opened and closed while the user executes a maintenance job inside the apparatus. The cover portion 14 also includes a tank cover 106 that is opened and closed in supplying the ink tank 108 with ink and a reading portion 110 capable of reading an image on a document. The reading portion 110 can be opened and closed in the same manner as the access cover 104 and is opened and closed during the maintenance job inside the apparatus or the like.

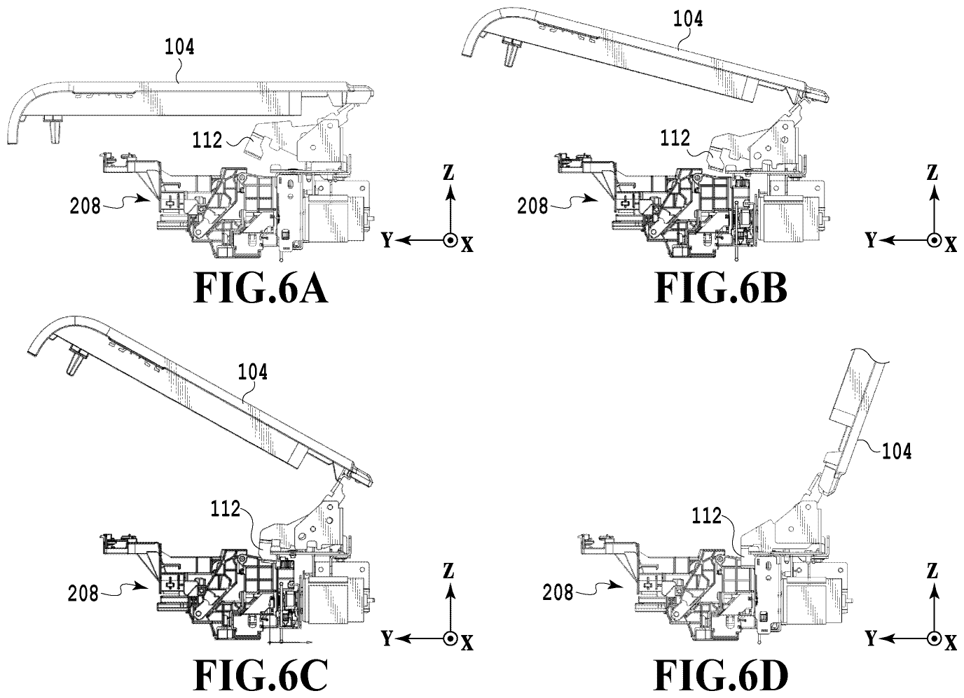

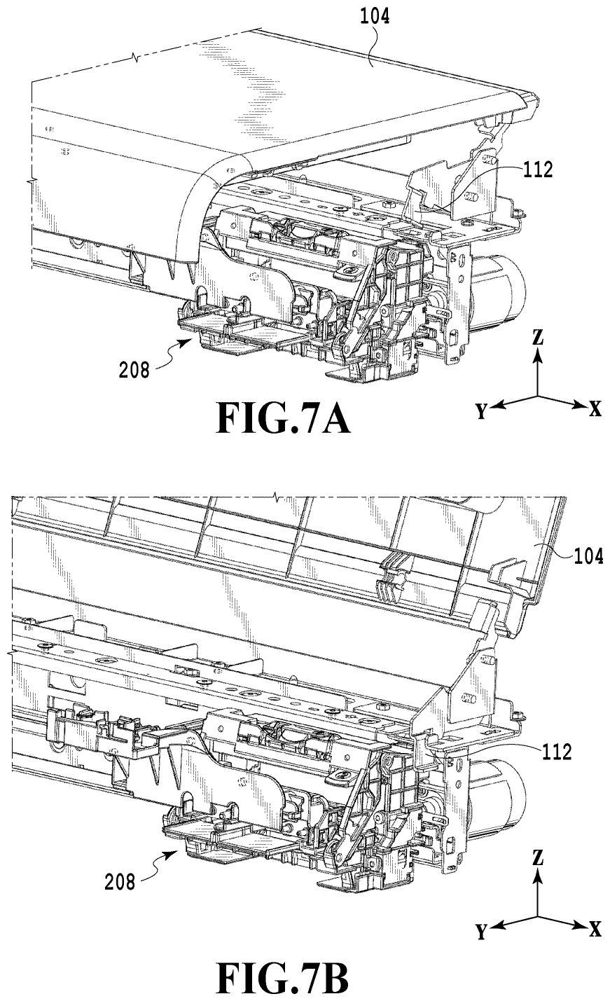

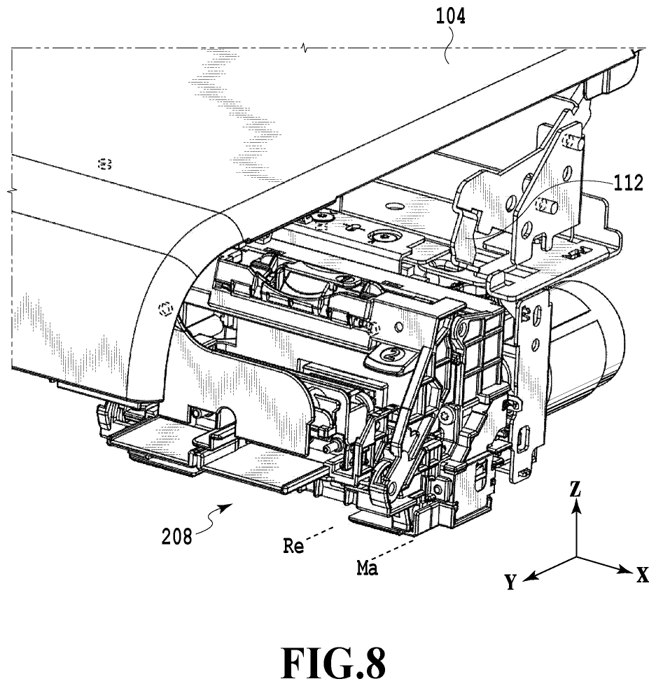

The cover portion 14 is provided with a projecting member 112 capable of moving between a projecting position where the projecting member 112 projects onto a movement path of the carriage and an evacuate position where the projecting member 112 evacuates from the movement path according to the opening and closing of the access cover 104. The projecting member 112 will be described in detail below with reference to FIGS. 6A to 8. FIGS. 6A to 6D are diagrams showing the position of the projecting member at the time of the opening and closing of the access cover. FIG. 6A shows the position of the projecting member in a case where the access cover is closed. FIG. 6B shows the position of the projecting member in a case where the access cover is opened by a certain amount. FIG. 6C shows the position of the projecting member in a case where the access cover is opened more than that in FIG. 6B. FIG. 6D shows a position in a case where the access cover is opened more than that in FIG. 6C, that is, the position of the projecting member in a case where the access cover is fully opened. FIGS. 7A and 7B are perspective views of the vicinity of the projecting member, FIG. 7A shows a state where the access cover is closed and corresponds to FIG. 6A, and FIG. 7B shows a state where the access cover is fully opened and corresponds to FIG. 6B. FIG. 8 is a perspective view of the vicinity of the projecting member in a case where the carriage reaches the engagement position.

In a state where the access cover 104 is closed, the projecting member 112 is located in the highest position, that is, the evacuate position (see FIG. 6A). In a case where the access cover 104 is opened, the projecting member 112 moves to a lower position continuously or stepwise according to the extent to which the access cover 104 is opened (see FIGS. 6B and 6C). Then, in a state where the access cover 104 is fully opened, the projecting member 112 is located in the lowest position, that is, the projecting position (see FIG. 6D). In a case state the access cover 104 is closed, as in FIG. 7A, the projecting member 112 is completely separated from the movement path of the carriage 208. Then, in a case where the access cover 104 is opened to a position shown in FIG. 6C, a portion of the projecting member 112 is located on the movement path of the carriage 208, and in a case where the access cover 104 is fully opened, the projecting member 112 is located on the movement path to a sufficient degree (see FIG. 7B).

In a case where the projecting member 112 is in the projecting position, the projecting member 112 can regulate movement of the carriage 208 to the downstream side in the +X direction of the projecting member 112 on the movement path. In the following description, a position in the movement path where the projecting member 112 in the projecting position is located is appropriately referred to as a “regulation position.” Further, in a case where the projecting member 112 is in the evacuate position, the projecting member 112 is not located in the movement path, so that the movement of the carriage 208 to the downstream side of the regulation position in the +X direction is permitted. It should be noted that downstream of the regulation position in the +X direction in the movement path, there are the maintenance portion 26 and the movement mechanism that uses the carriage 208 to move the gear 214 between a position where the gear 214 engages the gear 404 and a position where the gear 214 is away from the gear 404.

Thus, in the printing apparatus 10, in a state where the access cover 104 is fully opened, the carriage 208 cannot move downstream of the regulation position Re in the +X direction. Further, in a case where the access cover 104 is closed, the carriage 208 can move downstream of the regulation position Re in the +X direction. Then, the carriage 208 moves downstream of the regulation position Re in the +X direction, and thereby can press the movement mechanism and move to an engagement position Ma where the gear 214 and the gear 404 are engaged via the movement mechanism (see FIG. 8).

### Configuration of a Control System of the Printing Apparatus

Next, a description will be given of the configuration of a control system of the printing apparatus 10. FIG. 9 is a block diagram showing the configuration of the control system of the printing apparatus.

The printing apparatus 10 includes a Central Processing Unit (CPU) 902, a FlashROM 904, and a RAM 906. The CPU 902 is a central calculation processing portion in a microprocessor (microcomputer) form and controls the entire operation of the printing apparatus 10 by executing a program and activating hardware. Further, the CPU 902 is connected to each constituent to be described below via a system bus 950. The FlashROM 904 is connected to the CPU 902 via a ROM interface OF 903 and stores programs to be executed by the CPU 902 and various types of data necessary for various operations of the printing apparatus 10. The RAM 906 is connected to the CPU 902 via a memory controller 905 and is used as a work area for the CPU 902, as a temporary storage area for various types of received data, and for storing various types of setting data.

The printing apparatus 10 includes a host OF 908, and the CPU 902 is connected to a network 980 via the host OF 908 and is connectable to a host computer 982 via the network 980. The function of the input/output portion 16 may be held by the host computer 982. The input/output portion 16 may also be provided separately from the host computer 982 and the printing apparatus 10 via the network 980. The host computer 982 serves as an image data supply source and is installed with, for example, a printer driver. Incidentally, an external device connected to the printing apparatus 10 via the network 980 is not limited to the host computer 982 and may be, for example, a data providing device that serves as an image data supply source such as an image reading device, a digital camera, and a smart phone. The host OF 908 receives image data by stream notification from the host computer 982, and the supplied image data is stored in the RAM 906 via the memory controller 905. The printing apparatus 10 and the external device do not necessarily have to be connected via the network 980 and may be, for example, directly connected via wireless communication.

The printing apparatus 10 includes an input/output portion OF 910, and the CPU 902 is connected to the input/output portion 16 via the input/output portion I/F 910. As a result, the CPU 902 receives information from the input/output portion 16 and changes contents displayed in the display portion 16a. The printing apparatus 10 further includes an image processing portion 912. The image processing portion 912 performs various types of image processing of the image data, such as syntax analysis, resolution conversion into an effective number of pixels, image analysis, and image correction as necessary. The image processing portion 912 also converts color space (e.g., YCbCr) in image data on which necessary image processing has been performed into standard RGB color space (e.g., sRGB). The image processing portion 912 further performs processing such as converting the image data color-corrected in this manner into print data (data representing ink ejection and non-ejection in a pixel). The print data obtained with the image processing portion 912 is stored in the RAM 906.

The CPU 902 is connected to a reading head 916 and the print head 206 via a head OF 914. The CPU 902 uses the reading head 916 to read a document set in the reading portion 110. Read data read by the reading head 916 is stored in a storage area such as the RAM 906. Based on the print data, the CPU 902 prints an image on the print medium M by ejecting ink from each nozzle in the print head 206 in accordance with the conveyance of the print medium M by the conveying portion 20 and the position of the carriage 208 in the X direction.

The CPU 902 is connected via a motor driver 918 to a cutter motor 920 for driving the cutting portion 24, a conveying motor 922 for driving the conveying roller 202, and a maintenance motor 924 for driving the maintenance portion 26. The CPU 902 is also connected to a carriage motor 926 for moving the carriage 208 and a feeding motor 928 for rotating the roll R held by the holding portion 18. The feeding motor 928 is a motor capable of feeding the print medium M in cooperation with the conveying motor 922. At a predetermined time such as after the end of printing, the feeding motor 928 can rotate the roll R in a direction opposite to a direction at the time of conveyance during printing, pull back the print medium M, and separate the print medium M from the conveying roller 202. In this way, motors (including a motor which is not shown in FIG. 9) provided in the printing apparatus 10 are driven under the control of the CPU 902 via the motor driver 918.

The CPU 902 includes, via the sensor I/F 930, an open/close sensor 932 capable of detecting the opening and closing of each cover in the cover portion 14 and a position sensor 934 capable of detecting the position of the carriage 208 in the X direction. In addition to these sensors, the printing apparatus 10 includes various publicly-known sensors, and each sensor is connected to the CPU 902 via the sensor I/F 930.

### Maintenance Processing

In the printing apparatus 10 in the above configuration, maintenance processing in which the maintenance portion 26 performs a maintenance operation for the printing portion 22 is executed at a preset predetermined time. In the present embodiment, the maintenance processing is executed by combining a plurality of phases each including a plurality of maintenance operations. Further, the following description is given using, as an example, the case of executing the maintenance processing for filling the print head 206 with ink from the ink tank 108.

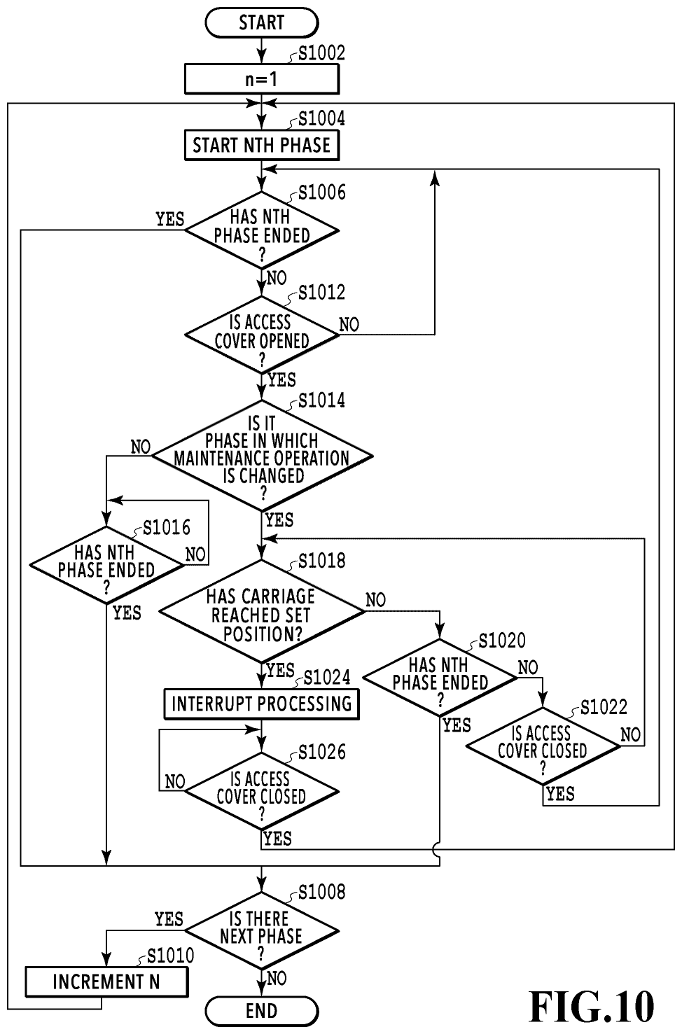

FIG. 10 is a flowchart showing a detailed process routine of the maintenance processing. A series of steps shown in the flowchart of FIG. 10 is performed by the CPU 902 expanding a program code stored in the FlashROM 904 into the RAM 906 and executing the program code. Alternatively, a portion or all of the functions of the steps in FIG. 10 may be executed in hardware such as an ASIC or electrical circuit. It should be noted that a symbol “S” in a description of each process means a step in a flowchart. The same applies hereinafter in the specification of the present application.

After the maintenance processing is started, the CPU 902 first sets a variable n representing the order of phases to be executed in the maintenance processing to “1” (S1002) and executes an nth phase (S1004). The phases constituting the maintenance processing are numbered in order of execution of processing, and in S1004, a phase corresponding to this information is executed.

Next, the CPU 902 determines whether the processing in the nth phase has ended (S1006). In S1006, it is determined whether all maintenance operations in the nth phase have ended. In a case where it is determined in S1006 that the processing in the nth phase has ended, the CPU 902 determines whether there is a next phase (S1008). In a case where it is determined that there is no next phase, the maintenance processing is ended. In a case where it is determined in S1008 that there is a next phase, n is incremented (S1010) and the process proceeds to S1004.

In a case where it is determined in S1006 that the processing in the nth phase has not ended, the CPU 902 determines whether the access cover 104 is opened based on the result of detection by the open/close sensor 932 (S1012). In the present embodiment, to facilitate understanding, the case of detecting the opening and closing only of the access cover 104 will be described. However, it may also be determined whether the reading portion 110 that can be opened and closed in the same manner as the access cover 104 is opened. In this case, it is determined in S1012 whether at least one of the access cover 104 and the reading portion 110 is opened.

In a case where it is determined in S1012 that the access cover 104 is not opened, the process returns to S1006. In a case where it is determined in S1012 that the access cover 104 is opened, the CPU 902 determines whether the nth phase is a phase in which it is necessary to change a maintenance operation by moving the carriage 208 (S1014). Incidentally, in a case where it is determined in S1012 that the access cover 104 is opened, a notification that prompts the closing of the access cover 104 may be made. Further, it is determined in S1014 whether the nth phase is the phase in which it is necessary to change the maintenance operation by moving the carriage 208. However, the present invention is not limited to this. During the maintenance processing, the time at which the carriage 208 moves is time to change the maintenance operation, so that it may also be determined in S1014 whether the nth phase is a phase including the movement of the carriage 208.

Here, the maintenance processing for filling the print head 206 with ink in the ink tank 108 includes, for example, four phases: a preparation phase, a first filling phase, a second filling phase, and a post-processing phase. The preparation phase is preprocessing for filling the print head 206 with ink and, for example, the print head 206 is capped so that ink can flow into the print head 206. This preparation phase includes, for example, a maintenance operation in which the nozzle surface 206a of the print head 206 is capped with the cap 210. This maintenance operation can be executed by changing the maintenance operation by moving the carriage 208. The first filling phase is a process of actually filling the print head 206 with ink. In this first filling phase, it is not necessary to change the maintenance operation by moving the carriage 208. The second filling phase is processing for adjusting the state of the print head 206 after ink filling. The post-processing phase is processing such that ink ejection from the print head 206 can be executed properly. The second filling phase and the post-processing phase include, for example, a maintenance operation of wiping the nozzle surface 206a of the print head 206, a maintenance operation of performing preliminary ejection into the cap 210, and the like. These maintenance operations can be executed by changing the maintenance operation by moving the carriage 208.

Thus, in a case where the nth phase is the preparation phase, the second filling phase, and the post-processing phase, it is determined in S1014 that the nth phase is a phase in which it is necessary to change the maintenance operation by moving the carriage 208. In a case where the nth phase is the first filling phase, it is determined in S1014 that the nth phase is not a phase in which it is necessary to change the maintenance operation by moving the carriage 208.

In a case where it is determined in S1014 that the nth phase is not a phase in which it is necessary to change the maintenance operation by moving the carriage 208, the CPU 902 determines whether the nth phase has ended (S1016). In a case where it is determined in S1016 that the nth phase has not ended, the process returns to S1016. In a case where it is determined in S1016 that the nth phase has ended, the process proceeds to S1008.

On the other hand, in a case where it is determined in S1014 that the nth phase is a phase in which it is necessary to change the maintenance operation by moving the carriage 208, the CPU 902 determines whether the carriage 208 has reached a set position (S1018). In S1018, it is determined based on the result of detection by the position sensor 934 whether the carriage 208 has reached the set position. The set position is a position (regulation position) where the carriage 208 contacts the projecting member 112 projecting onto the movement path, or a position upstream of the contact position in the +X direction by a certain amount, and is stored in a storage area such as the RAM 906.

In a case where it is determined in S1018 that the carriage 208 has not reached the set position, the CPU 902 determines whether the processing in the nth phase has ended (S1020). In a case where it is determined in S1020 that the processing in the nth phase has ended, the process proceeds to S1008. In a case where it is determined in S1018 that the processing in the nth phase has not ended, whether the access cover 104 is closed (S1022) is determined, and in a case where it is determined that the access cover 104 is not closed, the process returns to S1018. Further, in a case where it is determined in S1022 that the access cover 104 is closed, the process proceeds to S1006. In S1022, it is determined based on the result of detection by the open/close sensor 932 whether the access cover 104 is closed.

On the other hand, in a case where it is determined in S1018 that the carriage 208 has reached the set position, the CPU 902 interrupts a maintenance operation which is currently being executed (S1024) and determines whether the access cover 104 is closed (S1026). The specific details of processing in S1026 are the same as in S1022. In a case where it is determined in S1026 that the access cover 104 is not closed, the process returns to S1026. In a case where it is determined in S1026 that the access cover 104 is closed, the process returns to S1004. For example, it is assumed that the nth phase includes three maintenance operations and that the third maintenance operation is interrupted in S1024. In this case, after it is determined in S1026 that the access cover 104 is closed, the process returns to S1004, and the nth phase is started from the first maintenance operation. In the present embodiment, the CPU 902 functions as a control portion capable of controlling execution of the maintenance processing.

As described above, in the present embodiment, in a case where the access cover 104 is opened during maintenance processing including a plurality of phases in which a plurality of maintenance operations are executed, the processing is continued or interrupted according to the details of a phase which is being executed. Specifically, in a case where there is no maintenance operation that needs to be changed by moving the carriage 208 in the phase which is being executed, processing in the phase which is being executed is continued. Further, in a case where there is a maintenance operation that needs to be changed by moving the carriage 208 in the phase which is being executed, after the carriage 208 moves to the regulation position where the projecting member 112 regulates the movement of the carriage 208, processing which is being executed is interrupted. After that, in a case where the access cover 104 is closed, from the first maintenance operation in the phase in which the processing is interrupted, each maintenance operation in this phase is executed again.

As a result, in a case where the access cover 104 is opened during maintenance processing, the movement of the carriage 208 can be regulated by the projecting member 112. Additionally, in a case where the processing which is being executed is interrupted, processing is resumed from the first operation in the phase including the interrupted processing, so that the maintenance operations can be executed properly. Further, even in a case where the access cover 104 is opened in a phase including no maintenance operation, the processing in this phase is executed without interruption, so that an increase in time required for maintenance processing is suppressed.

### Second Embodiment

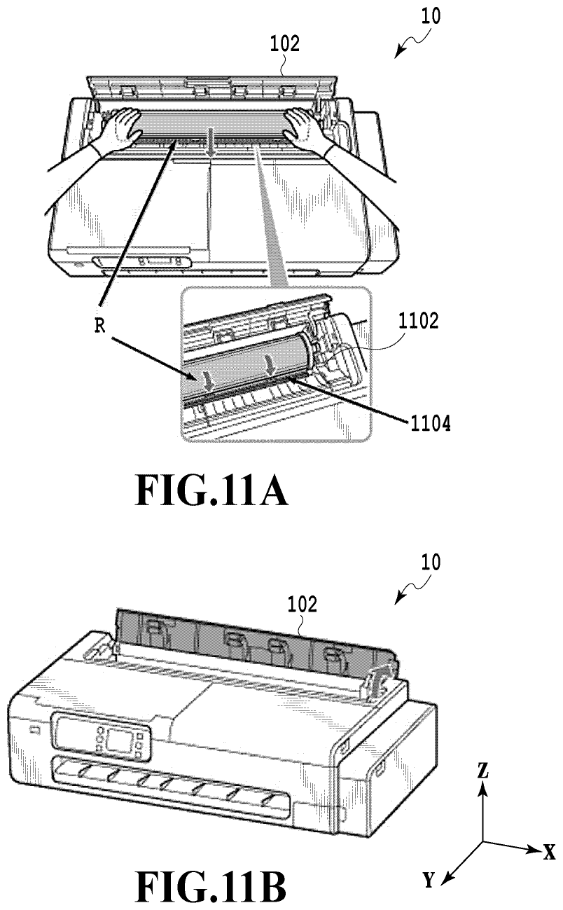

Next, a printing apparatus according to a second embodiment will be described with reference to FIGS. 11A to 14. In the following description, the same reference numeral as that used in the first embodiment is used for a constituent identical or corresponding to that of the printing apparatus according to the first embodiment described above, and a detailed description thereof is thus omitted.

In the printing apparatus 10, the driving force of the conveying motor 922 is transmitted to the maintenance portion 26 via the conveying roller 202, the gear 212, and the like to change a maintenance operation. Thus, in the case of executing maintenance processing including a plurality of phases including such a plurality of maintenance operations, the conveying roller 202 rotates. Therefore, the print medium M is pulled back toward the roll R by the holding portion 18 and is moved to a position away from the conveying roller 202 during not printing.

In the printing apparatus 10, in a case where the nozzle surface 206a of the print head 206 is not capped with the cap 210 for a certain period of time in a print standby state where a next print instruction is waited for, capping processing is performed to cap the nozzle surface 206a. Further, in the printing apparatus 10, the roll cover 102 can be opened and closed (see FIG. 11B) in order to set the roll R in a roll storage portion 1102 (see FIG. 11A) of the holding portion 18. FIGS. 11A and 11B are perspective views showing a state where the roll cover is opened.

Accordingly, in the printing apparatus 10, there is concern about the following situations in a case where during print standby and while the nozzle surface 206a is not capped, the job of setting the roll R in the roll storage portion 1102 is started or the roll cover 102 is opened.

In a case where the roll R is set in the roll storage portion 1102, the roll cover 102 is opened to expose the roll storage portion 1102 to the outside, and the roll R into which a paper tube is inserted is mounted in the roll storage portion 1102. After that, the print medium M is unwound from the roll R, inserted into the conveying path 1104, and pulled out to a predetermined position where the print medium M does not abut the conveying roller 202. Thus, in a case where capping processing is executed during setting of the roll R, there is a possibility that the conveying roller 202 may rotate and that the print medium M pulled out from the roll R may be pulled in by the conveying roller 202.

In a case where the roll cover 102 is opened while the roll R is set in the roll storage portion 1102, the print medium M pulled out from the roll R into the conveying path 1104 is located away from the conveying roller 202. As a result, in a case where the capping processing is started while the user is in contact with the roll R, there is a possibility that the print medium M that has shifted from the position separated by the contact and abuts the conveying roller 202 may be pulled into the conveying roller.

Thus, in the second embodiment, execution of the capping processing, which is maintenance processing executed during print standby, is controlled according to the opening and closing of the roll cover 102.

### First Capping Processing

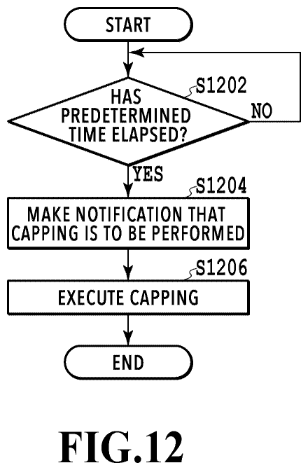

First, a description will be given of first capping processing executed during print standby. In the printing apparatus 10, for example, in a case where the printing apparatus enters a print standby state of waiting for a next print instruction in a state where printing based on a received print instruction has ended and where the nozzle surface 206a is not capped, the first capping processing is executed. FIG. 12 is a flowchart showing details of processing of the first capping processing during print standby. A series of steps shown in the flowchart of FIG. 12 is performed by the CPU 902 expanding the program code stored in the FlashROM 904 into the RAM 906 and executing the program code. Alternatively, a portion or all of the functions of the steps in FIG. 12 may be executed in hardware such as an ASIC or electrical circuit.

After the first capping processing is started, the CPU 902 first determines whether a predetermined time has elapsed since printing based on the previous print instruction had ended (S1202). The predetermined time is a time during which ink ejection from each nozzle of the print head 206 can be maintained well, and is determined experimentally according to an ink used, for example. In a case where it is determined in S1202 that the predetermined time has not elapsed, the process returns to S1202. Further, in a case where it is determined in S1202 that the predetermined time has elapsed, the CPU 902 makes a notification that the print head 206 is to be capped with the cap 210 on the display portion 16a of the input/output portion 16 (S1204). Incidentally, the processing of S1204 may be omitted. After that, the CPU 902 caps the print head 206 with the cap 210 (S1206) and ends this first capping processing. During print standby, the carriage 208 is moved to the predetermined position so that the print head 206 is located in the standby position. Accordingly, in S1206, the conveying motor 922 and the maintenance motor 924 are driven to cap the nozzle surface 206a of the print head 206 in the standby position with the cap 210.

### Roll Set Processing

Next, a description will be given below of roll set processing executed in storing the roll R in the roll storage portion 1102. In the case of storing the roll R in the roll storage portion 1102, the user presses, for example, a setting start button (not shown) in the input/output portion 16. In a case where the setting start button is pressed in the printing apparatus 10, it is determined that an instruction is given to start setting, and the roll set processing is started.

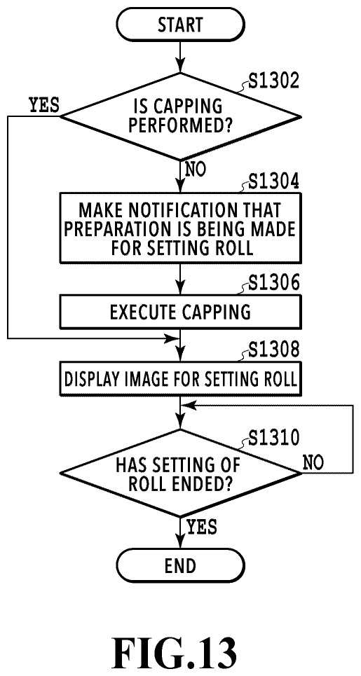

FIG. 13 is a flowchart showing details of processing of the roll set processing. A series of steps shown in the flowchart of FIG. 13 is performed by the CPU 902 expanding the program code stored in the FlashROM 904 into the RAM 906 and executing the program code. Alternatively, a portion or all of the functions of the steps in FIG. 13 may be executed in hardware such as an ASIC or electrical circuit.

After the roll set processing is started, the CPU 902 first determines whether the nozzle surface 206a of the print head 206 is capped (S1302). For example, the printing apparatus 10 is provided with a sensor capable of detecting that the nozzle surface 206a is capped with the cap 210. Therefore, in S1302, determination is made based on the result of detection by this sensor. Incidentally, various publicly-known techniques can be applied to determination as to whether the nozzle surface 206a of the print head 206 is capped with the cap 210.

In a case where it is determined in S1302 that the nozzle surface 206a is capped, the process proceeds to S1308 to be described later. Further, in a case where it is determined in S1302 that the nozzle surface 206a is not capped, the CPU 902 makes a notification that preparation is being made for setting the roll R (S1304). In S1304, for example, via the input/output portion 16, a message indicating that preparation is being made for setting the roll R is displayed, or voice guidance is played. As described above, in the present embodiment, the input/output portion 16 functions as a notification portion capable of notifying the user of various types of information. Next, the CPU 902 caps the nozzle surface 206a and enables the user to store the roll R in the roll storage portion 1102 (S1306). Here, in a case where the roll set processing is started while S1206 in FIG. 12 has not been completed during execution of the first capping processing described above, it is determined in S1302 that the nozzle surface 206a is not capped. Thus, the processing is also executed in the order of S1302 to S1304 and S1306 as in normal roll set processing in a case where the roll set processing is started during the first capping processing.

After that, the CPU 902 displays an image such as a processing procedure for setting the roll R and specific details of processing on the display portion 16a (S1308). After checking information displayed on the display portion 16a in S1308, the user inserts the roll R into the roll storage portion 1102, closes the roll cover 102, and presses a setting end button (not shown) displayed on the display portion 16a. After S1308, the process proceeds to S1310, and the CPU 902 determines whether the setting of the roll R in the roll storage portion 1102 has ended (S1310). Here, the end of setting of the roll R in S1310 is determined by the CPU 902 based on the end of mechanical processing, such as an operation of conveying the tip position of the roll R to a predetermined position, performed along with the user's press of the setting end button. In S1308, at least either of the above processing procedure and details of processing may be displayed, and any notification may be made as long as the user is prompted to set the roll R.

As described above, in the roll set processing, the roll R is guided to be set in the roll storage portion 1102 after capping the nozzle surface 206a. Thus, in a case where the user sets the roll R, the nozzle surface 206a is already capped. As a result, the conveying roller 202 does not rotate during setting of the roll R, and the print medium M pulled out from the set roll R is not pulled into the conveying roller 202.

### Second Capping Processing

Next, a description will be given of second capping processing executed in a case where the roll cover 102 is opened. Incidentally, in a case where the roll R is set in the roll storage portion 1102, the setting start button is pressed, so that even in a case where the roll cover 102 is opened, the second capping processing is not started and the roll set processing is started. Accordingly, this second capping processing is started in a case where the roll cover 102 is opened accidentally or the like. It should be noted that in a case where the second capping processing is started while the first capping processing is being executed, the first capping processing is forcibly ended.

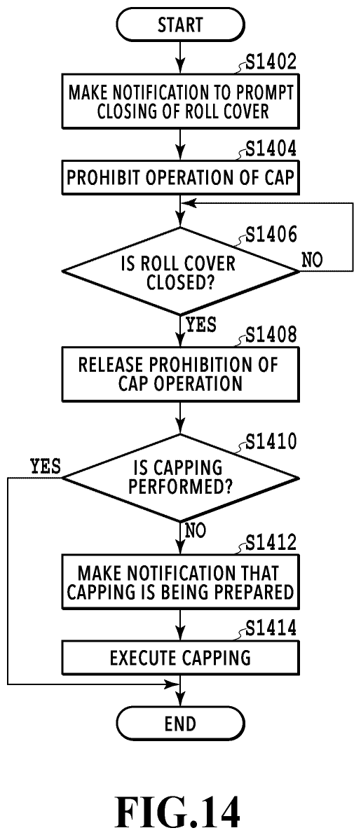

FIG. 14 is a flowchart showing details of processing of the second capping processing executed in a case where the roll cover 102 is opened. A series of steps shown in the flowchart of FIG. 14 is performed by the CPU 902 expanding the program code stored in the FlashROM 904 into the RAM 906 and executing the program code. Alternatively, a portion or all of the functions of the steps in FIG. 14 may be executed in hardware such as an ASIC or electrical circuit.

After the second capping processing is started, the CPU 902 first makes a notification to prompt the closing of the roll cover 102 (S1402). In S1402, for example, a message or an image prompting the closing of the roll cover 102 may be displayed on the display portion 16a, or voice guidance may be played via a speaker or the like. The CPU 902 then prohibits an operation of the cap 210 (S1404). In S1404, for example, a configuration to physically regulate the operation of the cap 210 may be provided to regulate the operation of the cap 210 or, for example, the CPU 902 may be configured not to drive the conveying motor 922 or maintenance motor 924. Incidentally, S1402 and S1404 may be executed in parallel, or the processing of S1402 may be executed after the processing of S1404.

After that, the CPU 902 determines whether the roll cover 102 is closed (S1406). In S1406, determination is made based on the result of detection by the open/close sensor 932. In a case where it is determined in S1406 that the roll cover 102 is not closed, the process returns to S1406. Further, in a case where it is determined in S1406 that the roll cover 102 is closed, the CPU 902 releases the prohibition of the operation of the cap 210 (S1408) and determines whether the nozzle surface 206a of the print head 206 is capped (S1410). The specific details of processing in S1410 are the same as in S1302 described above.

In a case where it is determined in S1410 that the nozzle surface 206a is capped, this second capping processing is ended. In a case where it is determined in S1410 that the nozzle surface 206a is not capped, the CPU 902 makes a notification that preparation is being made to cap the nozzle surface 206a (S1412). In S1412, a notification that preparation is being made for capping is made via the input/output portion 16. The CPU 902 then executes capping of the nozzle surface 206a (S1414) and ends this second capping processing.

As described above, in the second capping processing, in a case where the roll cover 102 is closed after the roll cover 102 is opened and the operation of the cap 210 is regulated, the nozzle surface 206a is capped. Thus, even in a case where the roll cover 102 is opened, capping is not executed while the user is in contact with the roll R. As a result, in a state where the roll cover 102 is opened, capping is not executed and the print medium M is not pulled into the conveying roller 202.

As described above, in the present embodiment, simply, in a case where the roll cover 102 is opened during the first capping processing, the operation of the cap 210 is regulated, and in a case where the roll cover 102 is closed, capping of the nozzle surface 206a is executed. Further, in a case where an instruction is given to start setting the roll R during the first capping, capping of the nozzle surface 206a is executed, and then the roll R is guided to be set in the roll storage portion 1102. As a result, even in a case where the roll cover 102 is opened during print standby, the print medium M is not pulled into the conveying roller 202 during the capping processing, which is maintenance processing, and the maintenance operations can be performed properly.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-090875, filed Jun. 3, 2022, which is hereby incorporated by reference wherein in its entirety.

What is claimed is:

1. A printing apparatus comprising:
a maintenance unit capable of executing maintenance processing including a plurality of maintenance operations for well maintaining and recovering liquid ejection from a printing unit configured to print a print medium; and
a control unit capable of controlling the maintenance processing and configured to, in a case where the maintenance processing is executed, execute first control to interrupt the maintenance processing in a case where the maintenance operations are changed by moving the printing unit.

2. The printing apparatus according to claim 1, wherein
in a case where the maintenance processing is executed, in a case where the maintenance operations are not changed by moving the printing unit, the control unit executes second control to continue the maintenance processing.

3. The printing apparatus according to claim 1, wherein
the printing unit ejects liquid while moving in a direction intersecting a direction of conveyance of the print medium by a convening unit configured to convey the print medium, and
the control unit executes the first control in a case where the printing unit moves to a predetermined position.

4. The printing apparatus according to claim 3, wherein
driving force of the conveying unit is transmitted to the maintenance unit based on movement of the printing unit to the predetermined position, and the maintenance unit changes the maintenance operations by the driving force.

5. The printing apparatus according to claim 3, wherein
the printing apparatus comprises a cover member displaceable between a closed position where an internal constituent of the printing apparatus is blocked from an outside and an open position where the internal constituent is exposed to the outside.

6. The printing apparatus according to claim 5, wherein
in a case where the maintenance processing is executed, in a case where the cover member is displaced from the closed position to the open position, the control unit executes the first control.

7. The printing apparatus according to claim 6, wherein
the control unit executes a second maintenance operation after executing a first maintenance operation in the maintenance processing and resumes the maintenance processing from the first maintenance operation after an interruption of the maintenance processing in a case where the cover member is displaced from the open position to the closed position during execution of the first maintenance operation.

8. The printing apparatus according to claim 5, wherein
the printing apparatus comprises a detection unit configured to detect opening and closing of the cover member.

9. The printing apparatus according to claim 5, further comprising:
a regulation unit configured to regulate the movement of the printing unit in a case where the cover member is in the open position.

10. A printing apparatus comprising:
a holding unit configured to hold a print medium;
a conveying unit configured to convey the print medium held by the holding unit;
a printing unit configured to print the print medium;
a cap configured to cap a nozzle surface on which a nozzle from which liquid is ejected is formed in the printing unit;
a cover member displaceable between a closed position where a storage portion storing the print medium in the holding unit is blocked from an outside and an open position where the storage portion is exposed to the outside; and
a control unit configured to execute a process of prompting setting of the print medium after capping the nozzle surface with the cap in a case where an instruction is given to start setting the print medium in the holding unit, regulate an operation of the cap in a case where the cover member is in the open position in a state where the instruction is not given to start setting the print medium in the holding unit, and release the regulation based on displacement of the cover member from the open position to the closed position to execute a process of capping the nozzle surface with the cap.

11. The printing apparatus according to claim 10, wherein
the control unit controls the cap so as to cap the nozzle surface in a case where a period of time during which the nozzle surface is not capped with the cap exceeds a predetermined period of time.

12. The printing apparatus according to claim 10, further comprising:
a notification unit capable of making a notification,
wherein the process of prompting setting is a process of making a notification, by the notification unit, of at least either of a processing procedure for setting the print medium and details of the processing.

13. The printing apparatus according to claim 10, wherein
the print medium to be set is a roll around which a sheet-like print medium is wound.

14. A method of controlling a printing apparatus comprising a maintenance unit capable of executing maintenance processing including a plurality of maintenance operations for well maintaining and recovering liquid ejection from a printing unit configured to print a print medium,
wherein in a case where the maintenance processing is executed, the maintenance operations are interrupted in a case where the maintenance operations are changed by moving the printing unit.

15. A method of controlling a printing apparatus comprising:
a holding unit configured to hold a print medium;
a conveying unit configured to convey the print medium held by the holding unit;
a printing unit configured to print the print medium;
a cap configured to cap a nozzle surface on which a nozzle from which liquid is ejected is formed in the printing unit; and
a cover member displaceable between a closed position where a storage portion storing the print medium in the holding unit is blocked from an outside and an open position where the storage portion is exposed to the outside,
wherein a process of prompting setting of the print medium is executed after capping the nozzle surface with the cap in a case where an instruction is given to start setting the print medium in the holding unit, and
wherein an operation of the cap is regulated in a case where the cover member is in the open position in a state where the instruction is not given to start setting the print medium in the holding unit, and the regulation is released based on displacement of the cover member from the open position to the closed position to cap the nozzle surface with the cap.
